(19) United States
(12) Patent Application Publication
(10) Pub. No.: US 2002/0095517 A1
(43) Pub. Date: Jul. 18, 2002

(54) Web-address conversion system and web-address conversion method

(75) Inventors: Koji Sasaki, Kyoto (JP); Shosuke Sasaki, Kyoto (JP); Norishige Furikado, Kyoto (JP); Ryuji Yukawa, Kyoto (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: J-DATA CO., LTD., Kyoto (JP)

(21) Appl. No.: 10/044,944

(22) Filed: Jan. 15, 2002

(30) Foreign Application Priority Data
Jan. 15, 2001 (JP) P2001-005989

(51) Int. Cl. G06F 15/16

(52) U.S. Cl. 709/246; 709/203

(57) ABSTRACT

An assignment server receiving access from a browser installed in a mobile telephone has a browser specifying clement specifying the type of browser and an assignment element changing the connection destination of the browser to a conversion server. The conversion server has a conversion table associating an identification number with a web content page address accessable from the browser. On receipt of a retrieval request designating the identification number, the conversion server sends a response designating the corresponding page address, so that the desired web content is displayed on the browser.

### BACKGROUND OF THE INVENTION

1. Field of the Invention

The present invention relates to the configuration of a system that supports web access using an identification number.

2. Description of the Background Art

In recent years, web access using a mobile telephone has flourished. The specification of a browser installed in a mobile telephone is different from that of a browser installed in a personal computer, etc. Further, the specification for the browser to be installed varies depending on the type of mobile telephone.

Therefore, there may be some web content that can be displayed on a personal computer but cannot be displayed on a mobile telephone. Also, there may be some web content that can be displayed on the mobile telephone of a certain mobile telephone company but cannot be displayed on the mobile telephone of other mobile telephone company.

In order to provide web content intended for mobile telephone users, it is necessary to create web content adapted for the browsers installed in mobile telephones, aside from web content adapted for personal computers.

Different page addresses (e.g., URLs (uniform resource locators)) are assigned to the web content adapted for the respective browsers installed in mobile telephones.

Consider now the case of opening certain web content to the public network on a web site. In order that the web content is accessible from different types of mobile telephones, it is required to create web content adapted for the respective mobile telephones and to assign different page addresses to the created web content.

In general, in order to access to the desired page by specifying a web site, the user designates a page address with a browser. The browser accesses to the web content corresponding to the inputted page address and displays the obtained information.

It is, however, a troublesome operation to input a character string of page address with the browser. In particular, on a compact portable digital assistant, buttons for performing input operation are small and spaced at short intervals, thereby making the input operation of a long character string very troublesome.

It is also required to input the page address adapted for the user's own mobile telephone. To search the page address of the desired web content, it becomes necessary to determine whether or not the site can be displayed by the user's mobile telephone (browser).

On the other hand, on such a web site that provides web content adapted for multiple types of mobile telephones, different page addresses corresponding to different types of mobile telephones are assigned to web content having the same content. It is therefore difficult to make these page addresses known to everyone.

For instance, when putting an advertisement for a certain page address in a magazine, etc., it is required to describe all the page addresses corresponding to their respective mobile telephones; otherwise a sufficient advertising effect would not be obtained. In addition, if the page address of the web content adapted for the browser installed in personal computers were to be described there, it would fail to provide an easy-to-view display.

### SUMMARY OF THE INVENTION

The present invention is directed to a system of converting web-addresses. According to his invention, the system comprises: a table holding element holding a conversion table in which web page identification numbers are assigned to respective page addresses of web content for each type of browser; a specifying element specifying a type of a browser when receiving an access request including a web page identification number from the browser; a searching element finding a page address accessible from the browser among the conversion table in response to the type of the browser and the web page identification number; an element responding to the browser in connection with the page-address found by the searching element.

With this configuration, the user can easily access to the desired web content by inputting an identification number, without concern for the type of browser.

According to one aspect of this invention, of web content created so as to correspond to different types of browsers, web content having approximately the same content is associated with the same identification number on the conversion table.

This facilitates identification number management.

Accordingly, an object of this invention is to provide a system with which it is easy to observe information irrespective of the type of terminal to be used, such as a mobile telephone or personal computer, while reducing troublesome input operation of the user performing a web access.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing the overall configuration of an address conversion system according to one preferred embodiment of the present invention;

FIG. 2 is a block diagram showing the configuration of the address conversion system;

FIGS. 3A, 3B, and 3C are diagrams showing a display state transition on the user's terminal when the address conversion system is used;

FIG. 4 is a diagram showing an example of conversion tables of a conversion server of a mobile telephone company (A-company); and

FIG. 5 is a diagram showing an example of conversion tables of a conversion server of other mobile telephone company (B-company).

### DESCRIPTION OF THE PREFERRED EMBODIMENTS

Preferred embodiments of the present invention will be described with reference to the accompanying drawings. <1, System Configuration>

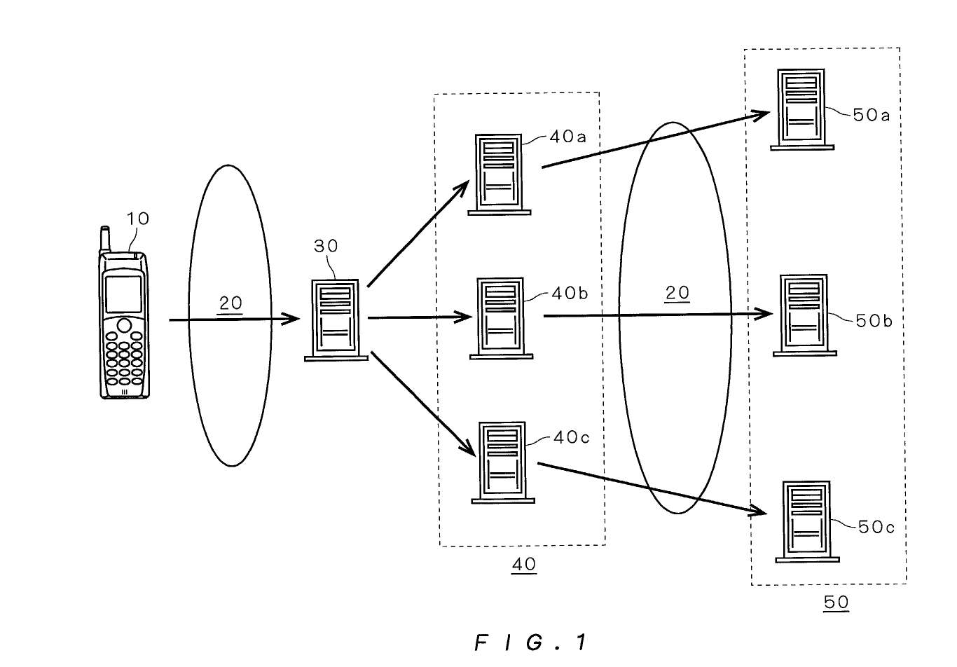

Referring to FIG. 1, the overall configuration of an address conversion system according to a preferred embodiment will be described below. The address conversion system provides an address conversion service in response to a request from a user's terminal 10 making use of the system. The user's terminal 10 can easily access to a web content at content site 50 by the use of the system.

The address conversion system consists of an assignment server 30 and conversion server 40. The conversion server 40 is equipped with three conversion servers 40a, 40b, and 40c that correspond to different types of mobile telephones.

In this preferred embodiment, the address conversion system provides service adapted for three mobile telephone companies (A-company, B-company, and C-company). The conversion servers 40a, 40b, and 40c correspond to A-company, B-company, and C-company, respectively.

In FIG. 1, there are shown a plurality of content sites, 50a, 50b and 50c, as the content site 50. The content sites 50a, 50b and 50c have web content adapted for the browsers used in the mobile telephones of A-company, B-company, and C-company, respectively.

Since the specification for the browser installed in the mobile telephone varies from one company to another, the content sites 50a, 50b and 50c have web content adapted for their corresponding mobile telephone. Specifically, these have content created in a page description language adapted for the browser installed in each mobile telephone.

This preferred embodiment describes the case that the type of web content varies from one content site to another, for sake of simplicity. Even in a case where a single content site has web content adapted for different types of mobile telephones, the address conversion system of the preferred embodiment produces the same effect, without causing any problem.

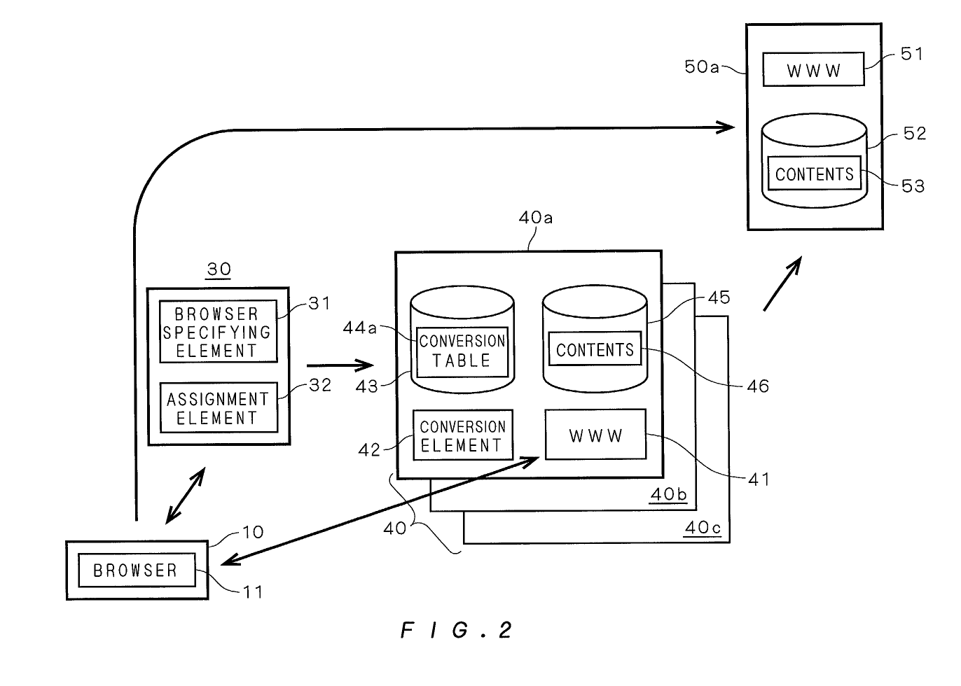

Referring to FIG. 2, the user's terminal 10 is a mobile telephone equipped with a web-accessible browser 11.

The content site 50a has a WWW server application 51 (hereinafter referred to as a “WWW 51”), and opens to internet 20 web content 53 stored in storage unit 52.

In this preferred embodiment, the user's terminal (mobile telephone) 10 is A-company's mobile telephone, and it can observe the web content 53 of the content site 50a by using the browser 11.

The assignment server 30 comprises a browser specifying element 31 and assignment element 32. The browser specifying element 31 is an element determining the type of access source browser. Specifically, the browser specifying element 31 specifies to which mobile telephone company the user's terminal 10 belongs, from TP address of the access source mobile telephone. As a result, the type of browser 11 is specified.

That is, web services using mobile telephones are conducted through the servers which are prepared by the mobile telephone service companies, and the servers are provided with IP addresses each having a combination of a domain name and a sub-domain name intrinsic to each server. In general, the network addresses of mobile telephones are in the form of: “provate_code@asss.uuu.com”, for example, and the domain name “uuu” and/or the sub-domain name “sss” represents the network service of the mobile telephone company. Further, only one or more limited type(s) of mobile telephones and only one or more limited type(s) of browsers can be used for network access through the network service of each mobile company. Thus, the domain name and/or sub-domain name of the mobile telephone has information sufficient to identify the type of mobile telephone and/or the type of the browser installed in each mobile telephone. The system according the preferred embodiment is operable to convert the combination of:

1) a series of numbers (a web page identification number) representing a web page address designated; and

2) a network address of the terminal (the mobile telephone) having an address part reflecting a type of the terminal, to a web address accessible by the terminal.

The assignment element 32 is an element that sends a response designating the page address (e.g., URL) of the corresponding conversion server 40, depending on the type of browser 11. That is, when the type of browser installed in the user's terminal 10 is specified by the browser specifying element 31, the assignment element 32 returns the browser 11 the page address of the conversion server 40, which corresponds to the browser 11. In the instance of FIG. 2, since a response designating the page address of the conversion server 40a is sent to the browser 11, the web access destination of the user's terminal 10 is changed to the conversion server 40a. Similarly, in case of the mobile telephones of B-company and C-company, their destinations are changed to the conversion servers 40b and 40c, respectively.

The conversion server 40 provides the following service. That is, on receipt of an access request designating an identification number, which will be described later, from the browser 11 of the user's terminal 10, the conversion server 40 converts the identification number to the corresponding page address, and sends the browser 11 a response designating this page address.

Description will next be made of the configuration of the conversion server 40a. The conversion servers 40b and 40c are the same as the conversion server 40a, except for the data stored in their conversion tables and the content of web content.

Referring again to FIG. 2, the conversion server 40a has a WWW server application 41 (hereinafter referred to as a “WWW 41”), and opens to the internet 20 web content 46 stored in a storage unit 45. That is, the conversion server 40a has the function as a general web site. The web content 46 of the conversion server 40a is created in a page description language adapted for the browser used in A-company's mobile telephone. Similarly, web content 46 of the conversion servers 40b and 40c are created in a page description language adapted for the browser used in B- and C-companies′ mobile telephones, respectively.

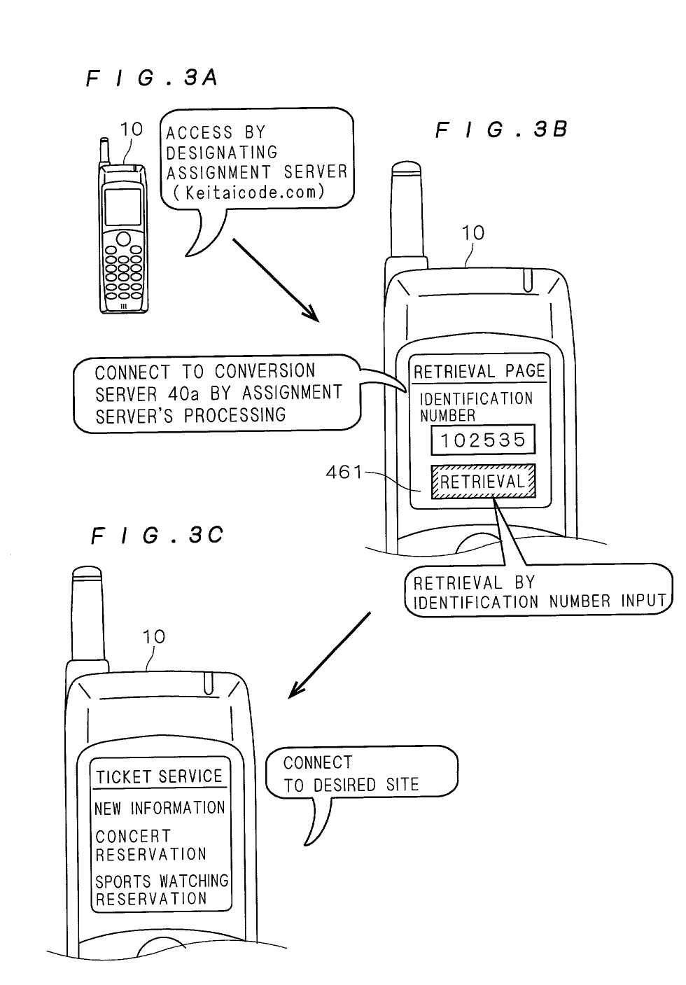

The web content 46 includes a retrieval page 461 for providing an identification-number retrieval service to the user. FIG. 3B exemplifies the state that the retrieval page 461 is displayed on the monitor of a mobile telephone. The retrieval page 461 has content including an identification-number input form and a retrieval execution object. Therefore, the user can first access to the retrieval page 461 and then perform the retrieval operation using an identification number.

The conversion server 40 is also equipped with a conversion element 42 and an address conversion table 44a stored in a storage unit 43.

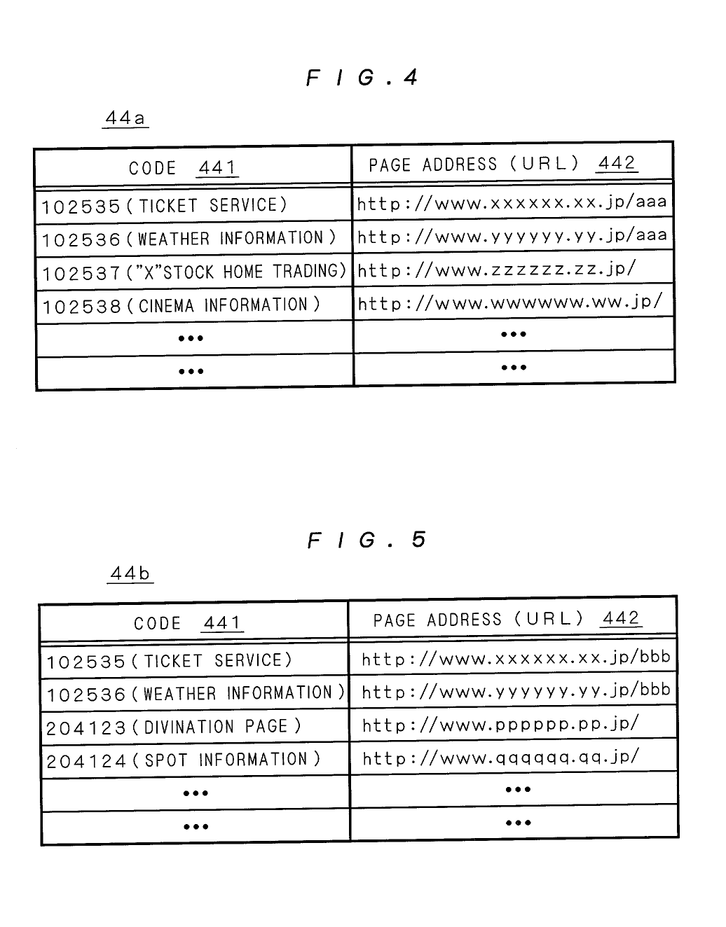

FIG. 4 exemplifies the address conversion table 44a, which is a data base associating an identification number (code) 441 and page address (URL) 442.

Referring to FIG. 4, the identification number 441 is a code of a 6-digit number, and an individual code is accompanied by description of the home page corresponding to the code (identification number 441), for the sake of convenience. Although in this embodiment the identification number 441 is composed of a 6-digit number, some characters may be included therein. Although no special limitation is imposed on the number of digits, a lesser number of digits is preferable for avoiding troublesome input operation.

The conversion element 42, which can be called from the retrieval page 461 previously described, is an element executing retrieval processing in the backyard of the WWW 41. The conversion element 42 has a link function with a data base. Using tie identification number 441 designated on the retrieval page 461, as key information, the conversion element 42 retrieves the conversion table 44a to obtain the corresponding page address 442.

After obtaining the page address 442, the conversion element 42 sets the link destination of the browser 11 of the user's terminal 10, to the obtained page address 442. As a result, the web content corresponding to the page address 442 is displayed on browser 11. For instance, when the link destination is the web content of the web site 50a, certain web content in the web content 53 is displayed on browser 11.

Hereafter, every page address 442 entered in the conversion table 44a is the page address that corresponds to web content accessible from A-company's mobile telephone (browser). In consequence, when the link destination is changed by the conversion element 42, accessible web content is properly displayed on the browser of the user's terminal 10.

Thus, the conversion server 40 executes the foregoing processing to provide the user with the retrieval service of the identification number 441.

<2. Processing Flow>

Processing flow of the address conversion system so configured will be described with reference to FIGS. 3A, 3B, and 3C.

Referring now to FIG. 3A, the user accesses to the assignment server 30 by performing a predetermined keyboard operation on the user's terminal 10.

The term “predetermined keyboard operation” means the operation of internet connection that varies depending on the mobile telephone, and the operation of address designation to the assignment server 30. The address designation to the assignment server 30 is executable by direct input of page address. This is also executable, if there is a link from other site, by temporally making a connection to this site and designating a link from this site.

From the second and later access, the address designation to the assignment server 30 can be omitted by storing the page address in “bookmark.” This will be described later.

By the operation of address designation to the assignment server 30, the browser 11 of the user's terminal 10 accesses to the assignment server 30. On receipt of an access request from browser 11, the browser specifying element 31 obtains the IP address of the user's terminal 10, and specifies the type of browser. In this instance, it is specified that the user's terminal 10 is A-company's mobile telephone, and the browser 11 is the browser installed in A-company's mobile telephone. Then, the assignment element 32 sends a response designating the page address of the conversion server 40a, so that the link destination of the browser 11 is changed to the conversion server 40a. As a result, the retrieval page 461 of the conversion server 40a is displayed on the browser 11, as shown in FIG. 3B.

Subsequently, the user inputs the desired web content identification number on the retrieval page 461. The user can obtain in advance the desired web content identification number in a magazine or advertisement, or on internet. The identification number so obtained is, for example, composed of a 6-digit number, as in this preferred embodiment. This facilitates making a note of the identification number, unlike a long page address character sting. This also facilitates the input operation of the identification number while viewing the magazine or advertisement. In FIG. 3B, the identification number, “102535”, is inputted.

When the identification number “102535” is inputted on the retrieval page 461 and the retrieval instruction is executed, the conversion server 40a performs a page address retrieval processing with the conversion element 42. That is, using the obtained identification number 441 as key information, the conversion element 42 executes the retrieval processing to the conversion table 44a in FIG. 4, thereby to obtain the page address 442 corresponding to the identification number 441. In this instance, page address “http://www.xxxxxx.xxjp/aaa” corresponding to the identification number “10253” is obtained.

After obtaining the page address corresponding to the identification number, the conversion element 42 changes the link destination of the browser 11 to the obtained page address. Hereafter, the page address, “http://www.xxxxxx.xx.jp/aaa”, indicates the home page of ticket service. Accordingly, the ticket service page is displayed on the browser 11 of the user's terminal 10, as shown in FIG. 3C. Such a reliable display of web content on the browser 11 is attainable by the fact that every page address 442 entered in the conversion table 44a is the page address accessible from the user's terminal 10, as stated above.

Thus, the user of the user's terminal 10 can observe the desired web content without concern for the specification for the browser installed in the user's terminal 10 (i.e., without concern for the type of his/her own mobile telephone).

Each browser has the function of storing the site that the user visited once (e.g., the function indicated by “favorite” or “bookmark”). When visiting again the same content site, the page address input can be omitted by using such function.

When the user's terminal 10 accesses to the assignment server 30, the assignment element 32 is automatically executed to make a connection to the conversion server 40a (tic state shown in FIG. 3B). That is, when the user accesses to the assignment server 30 and stores the page address in “bookmark”, the page address of the conversion server 40a is stored in the bookmark. Therefore, from the second and later access, a designation from the bookmark connects the user's terminal 10 directly to the conversion server 40a. At the time of the second and later access, the user is merely required to access to the conversion server 40a by designation from the bookmark, and input an identification number to execute a retrieval operation, thus completely eliminating any character input operation that is troublesome.

<3. Identification Number Assignment>

FIG. 5 exemplifies a conversion table 44b of the conversion server 40b. The conversion server 40b is a conversion site corresponding to the browser installed in B-company's mobile telephone. An individual page address associated with an identification number on the conversion table 44b is the page address of web content that is created so as to correspond to the browser of B-company's mobile telephone.

Like the above conversion server 40a, the conversion server 40b provides an address conversion service to a web access from B-company's mobile telephone, by using the conversion table 44b.

The identification number “102535” of the conversion table 44a in FIG. 4, and the identification number “102535” of the conversion table 44b in FIG. 5, indicate the web content of the same ticket service.

That is, the page address, “http://www.xxxxxx.xx.jp/aaa”, corresponding to the identification number “102535” of the conversion table 44a, and the page address, “http//www.xxxxxx.xxjp/bbb”, corresponding to the identification number “102535” of the conversion table 44b in FIG. 5, indicate the web content having the same content (ticket service), and this is web content created in a page description language adapted for their respective browser. Therefore, A-company's mobile telephone is accessable to “http://www.xxxxxx.xxjp/aaa”, but inaccessible to “http://www.xxxxxx.xxjp/bbb”. In contrast, B-company's mobile telephone is accessable to “http://www.xxxxxx.xxjp/bbb”, but inaccessible to “http://www.xxxxxx.xx.jp/aaa”.

Thus, the same identification number is assigned to the web content having the same content although their respective browsers arc different from each other. Thereby, even when an identification number is obtained in a magazine or advertisement, it is unnecessary that the user determines to which browser the identification number corresponds.

In addition, on the content provision side, the same web content can be managed with the identification number common to all the mobile telephone companies (browsers). Even in describing a certain identification number on an advertising medium, only one common identification number is enough. There is no need to describe the page address of long character string, or a plurality of identification numbers corresponding to all the mobile telephone companies, as well as the identification number for personal computer.

<4. Modifications>

Although in the foregoing embodiment the conversion servers 40a, 40b, and 40c are configured separately from each other, as shown in FIGS. 1 and 2, these may be realized in a single server. In the alternative, these and the assignment server 30 may be realized in a single server.

Regardless of whether or not the conversion servers 40a, 40b, and 40c are realized in a single server (hardware), these can also be configured so as to share the same conversion table. In the conversion tables 44a and 44b shown in FIGS. 4 and 5, the page address 442 is retrieved by using the identification number 441 as key information. On the other hand, when the conversion servers 40a, 40b, and 40c share the same conversion table, the retrieval of page address 442 may be performed on this conversion table by using the identification number 441 and the mobile telephone type discriminating number (browser type discriminating number), as key information.

Although the foregoing embodiment employs the conversion servers 40a, 40b and 40c adapted for the three mobile telephone companies, A-company, B-company, and C-company, it is possible to place a conversion server adapted for the browser installed in any type of digital assistant, irrespective of the mobile telephone company. In the alternative, a conversion server adapted for the browsers installed in personal computers may be placed. This enables to provide an address conversion service in response to access from any type of terminal, such as mobile telephones, portable digital assistants and personal computers.

Accordingly, no special limitation is imposed on the server configuration, and any suitable modification is possible in consideration of load distribution and maintenance.

The address conversion system of the foregoing embodiment is also applicable to a single content site. Specifically, a certain content site can configure by itself such an address conversion system in which the user's terminals visiting the top page of the content site are assigned depending on the specification for browser, thereby providing a retrieval service corresponding to the browser.

While the invention has been shown and described in detail, the foregoing description is in all aspects illustrative and not restrictive. It is therefore understood that numerous modifications and variations can be devised without departing from the scope of the invention.

What is claimed is:

1. A system of converting web-addresses, comprising:
a table holding element holding a conversion table in which web page identification numbers are assigned to respective page addresses of web content for each type of browser;
a specifying element specifying a type of a browser when receiving an access request including a web page identification number from said browser;
a searching element finding a page address accessible from said browser among said conversion table in response to said type of said browser and said web page identification number; and
an element responding to said browser in connection with said page-address found by said searching element.

2. A system of converting web-addresses, comprising:
a table holding element holding a conversion table in which page-identification numbers are assigned to respective page addresses of web content for each type of mobile telephones;
a specifying element specifying a type of a mobile telephone when receiving an access request including a web page identification number from said mobile telephone;
a searching element finding a page address accessible from said mobile telephones among said conversion table in response to said type of said mobile telephone and said web page identification number; and
an element responding to said mobile telephone in connection with said page-address found by said searching element.

3. The system according to claim 2, wherein
said specifying element includes
an element obtaining an internet address of said mobile telephone to specify the type of said mobile telephone.

4. The system according to claim 1, wherein
a same web page identification number is assigned to web content having approximately the same content for different types of browsers on said conversion table.

5. A system of converting web-addresses, comprising:
an assignment server; and
multiple conversion servers assigned to respective types of browsers,
said assignment server comprising:
a specifying element specifying a type of a browser installed in a terminal when receiving an access request including a web page identification number from said browser;
an element specifying a conversion server among said multiple conversion servers corresponding to the type of said browser to transfer a connection from said terminal to said conversion server, and
each of said multiple conversion servers comprising:
a table holding element holding a conversion table in which page-identification numbers are assigned to respective page addresses of web content;
a searching element finding a page address accessible from said browser among said conversion table in response to said web page identification number; and
an element responding to said browser in connection with said page-address found by said searching element.

6. A method of converting web-addresses, comprising the steps of:
holding a conversion table in which page-identification numbers are assigned to respective page addresses of web content for each type of browser;
receiving an access request including a web page identification number from a browser installed in a terminal;
obtaining a network address of said terminal to specify a type of a browser;
converting said web page identification number to a page address accessible from said terminal; and
responding said browser in connection with said page-address found by said step of converting to establish a connection between said terminal and said page-address.

7. An address converter comprising:
a receiver receiving an access request from a terminal through a network, wherein said access request includes
a series of numbers representing a web page address, and
a network address of said terminal having an address part reflecting a type of said terminal;
a converter converting a combination of said network address and said series of numbers to a web addresses; and
an element operable to respond said terminal in connection with said page-address to establish a connection between said terminal and said page-address.
